(19) United States
(12) Patent Application Publication
(10) Pub. No.: US 2025/0328226 A1
(43) Pub. Date: Oct. 23, 2025

(54) METHOD FOR PROVIDING NON-DESTRUCTIVE EDITING FUNCTION AND ELECTRONIC DEVICE SUPPORTING SAME

(71) Applicant: Samsung Electronics Co., Ltd., Suwon-si (KR)

(72) Inventors: Younghun JOO, Suwon-si (KR); Joohyung LEE, Suwon-si (KR); Hyemin KIM, Suwon-si (KR); Sohee HONG, Suwon-si (KR)

(21) Appl. No.: 19/256,752

(22) Filed: Jul. 1, 2025

Related U.S. Application Data
(63) Continuation of application No. PCT/KR2023/020885, filed on Dec. 18, 2023.

(30) Foreign Application Priority Data
Jan. 10, 2023 (KR) 10-2023-0003339
Feb. 6, 2023 (KR) 10-2023-0015463

(51) Int. Cl. G06F 3/04845

(52) U.S. Cl. CPC G06F 3/04845

(57) ABSTRACT

An electronic device is provided. The electronic device includes communication circuitry, at least one processor including processing circuitry, and memory storing instructions, wherein the instructions, when executed by the at least one processor individually or collectively, cause the electronic device to receive, from an external electronic device through the communication module, first content, the original content of the first content, and metadata of the first content, identify whether operating system (OS) of the external electronic device is the same as OS of the electronic device, based on identifying that the OS of the external electronic device is not same as the OS of the electronic device, change a path of the original content included in the metadata to a path related to the OS of the electronic device, and based on identifying that the OS of the external electronic device is same as the OS of the electronic device, maintain the path of the original content included in the metadata.

### CROSS-REFERENCE TO RELATED APPLICATION(S)

This application is a continuation application, claiming priority under 35 U.S.C. § 365(c), of an International application No. PCT/KR2023/020885, filed on Dec. 18, 2023, which is based on and claims the benefit of a Korean patent application number 10-2023-0003339, filed on Jan. 10, 2023, in the Korean Intellectual Property Office, and of a Korean patent application number 10-2023-0015463, filed on Feb. 6, 2023, in the Korean Intellectual Property Office, the disclosure of each of which is incorporated by reference herein in its entirety.

### BACKGROUND

### 1. Field

The disclosure relates to a method for providing a non-destructive editing function and an electronic device supporting the same.

### 2. Description of Related Art

An electronic device, such as a smartphone provides a function of editing content (e.g., images). For example, the electronic device may obtain an image through a camera and apply a filter (e.g., a filter that applies a visual effect to the image) to the obtained image, thereby obtaining an edited image having different properties from the properties of the obtained image.

The electronic device may provide a non-destructive editing function that, when edited content is obtained by editing content, restores the content prior to the editing from the edited content or allows the restored content to be edited.

The above information is presented as background information only to assist with an understanding of the disclosure. No determination has been made, and no assertion is made, as to whether any of the above might be applicable as prior art with regard to the disclosure.

### SUMMARY

When obtaining edited content by editing original content, an electronic device may store the original content in a path related to an operating system (OS) of the electronic device (e.g., a path unique to the OS of the electronic device), and obtain (e.g., generate) metadata (e.g., metadata of the edited content) including the path.

The electronic device may receive, from an external electronic device, original content, edited content, and metadata of the edited content including a path of the original content.

When an OS of the external electronic device is same as the OS of the electronic device, the electronic device may store the original content in the path of the original content included in the metadata (e.g., the path unique to the OS of the external electronic device).

On the contrary, when the OS of the external electronic device is different from the OS of the electronic device, the electronic device may have a problem in that it may not store the original content in the path of the original content included in the metadata (e.g., the path unique to the OS of the external electronic device). Moreover, when the electronic device stores the original content in a path different from the path of the original content included in the metadata, the path of the original content included in the metadata (the metadata of the edited content) and the path in which the original content is actually stored may be different. In this case, the electronic device may have difficulty performing a non-destructive editing function (e.g., an operation of restoring the original content) for the edited content.

Aspects of the disclosure are to address at least the above-mentioned problems and/or disadvantages and to provide at least the advantages described below. Accordingly, an aspect of the disclosure is to provide a method for providing a non-destructive editing function, and an electronic device supporting the same, which when original content, edited content, and metadata including a path of the original content are received from an external device operating on an OS different from an OS of the electronic device, may provide the non-destructive editing function for edited content by changing the path of the original content in the metadata to a path related to the OS of the electronic device and storing the original content in the changed path.

Additional aspects will be set forth in part in the description which follows and, in part, will be apparent from the description, or may be learned by practice of the presented embodiments.

In accordance with an aspect of the disclosure, an electronic device is provided. The electronic device includes communication circuitry, at least one processor including processing circuitry, and memory storing instructions, wherein the instructions, when executed by the at least one processor individually or collectively, cause the electronic device to receive, from an external electronic device through the communication module, first content, original content of the first content, and metadata of the first content identify whether an OS of the external electronic device is same as an OS of the electronic device, based on identifying that the OS of the external electronic device is not same as the OS of the electronic device, change a path of the original content included in the metadata to a path related to the OS of the electronic device, and based on identifying that the OS of the external electronic device is same as the OS of the electronic device, maintain the path of the original content included in the metadata.

In accordance with another aspect of the disclosure, a method for providing a non-destructive editing function in an electronic device is provided. The method includes receiving, through a communication module of the electronic device, first content, original content of the first content, and metadata of the first content from an external electronic device, identifying whether an OS of the external electronic device is identical to an OS of the electronic device, based on identifying that the OS of the external electronic device is not same as the OS of the electronic device, changing a path of the original content included in the metadata to a path related to the OS of the electronic device, based on identifying that the OS of the external electronic device is same as the OS of the electronic device, maintaining the path of the original content included in the metadata.

In accordance with another aspect of the disclosure, in one or more non-transitory computer-readable storage media storing one or more computer programs including computer-executable instructions that, when executed by a processor of an electronic device, cause the electronic device to perform operations are provided. The operations include receiving, through a communication module of the electronic device, first content, original content of the first content, and metadata of the first content, identifying whether an OS of the external electronic device is same as an OS of the electronic device, based on identifying that the OS of the external electronic device is not same as the OS of the electronic device, changing a path of the original content included in the metadata to a path related to the OS of the electronic device, and based on identifying that the OS of the external electronic device is same as the OS of the electronic device, maintaining the path of the original content included in the metadata.

In accordance with another aspect of the disclosure, an electronic device is provided. The electronic device includes communication circuitry, at least one processor including processing circuitry, and memory storing instructions, wherein the instructions, when executed by the at least one processor individually or collectively, cause the electronic device to receive, from an external electronic device through the communication module, first content, original content of the first content, and metadata of the first content, identify whether an OS of the external electronic device is same as an OS of the electronic device, based on identifying that the OS of the external electronic device is not same as the OS of the electronic device, change a path of the original content included in the metadata to a path related to the OS of the electronic device, and based on identifying that the OS of the external electronic device is same as the OS of the electronic device, maintain the path of the original content included in the metadata.

In an embodiment of the disclosure, a method for providing a non-destructive editing function and an electronic device supporting the same provides a non-destructive editing function for edited content by, when receiving original content, edited content, and metadata including a path of the original content from an external electronic device operating using an OS different from an OS of the electronic device, changing the path of the original content in the metadata to a path related to the OS of the electronic device, and storing the original content in the changed path.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an electronic device according to an embodiment of the disclosure;

FIG. 3 is a flowchart illustrating a method for obtaining non-destructively editable content according to an embodiment of the disclosure;

FIG. 4 is a diagram illustrating a method for obtaining non-destructively editable content according to an embodiment of the disclosure;

FIG. 5 is a flowchart illustrating a method for providing a non-destructive editing function according to an embodiment of the disclosure;

FIG. 6 is a flowchart illustrating a method for providing a non-destructive editing function according to an embodiment of the disclosure;

FIG. 7 is a diagram illustrating a method for providing a non-destructive editing function according to an embodiment of the disclosure;

FIG. 8 is a flowchart illustrating a method for providing a non-destructive editing function according to an embodiment of the disclosure; and

FIG. 9 is a diagram illustrating a method for providing a non-destructive editing function according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

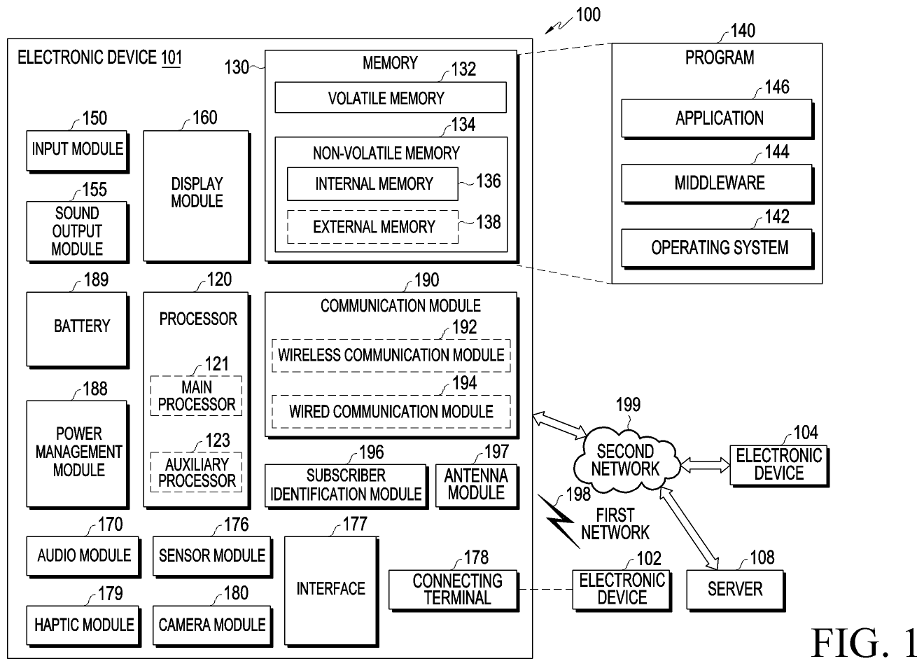

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the strength of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form an mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment of the disclosure, the module may be implemented in a form of an application-specific integrated circuit (ASIC).

An embodiment of the disclosure as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment of the disclosure, each component (e.g., a module or a program) of the above-described components may include a single entity or multiple entities, and some of the multiple entities may be separately disposed in different components. According to an embodiment of the disclosure, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment of the disclosure, operations performed by the module, the program, or another component may be carried out sequentially, in parallel, repeatedly, or heuristically, or one or more of the operations may be executed in a different order or omitted, or one or more other operations may be added.

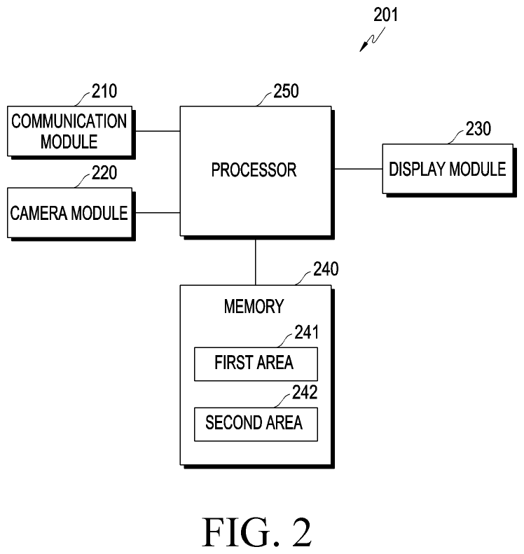

FIG. 2 is a block diagram illustrating an electronic device 201 according to an embodiment of the disclosure.

Referring to FIG. 2, in an embodiment of the disclosure, the electronic device 201 may be the electronic device 101 of FIG. 1.

In an embodiment of the disclosure, the electronic device 201 may include a communication module 210, a camera module 220, a display module 230, memory 240, and/or a processor 250.

In an embodiment of the disclosure, the communication module 210 may be the communication module 190 of FIG. 1.

In an embodiment of the disclosure, the communication module 210 may transmit or receive content and information related to the content to or from an external electronic device. For example, when original content of the content exists, the communication module 210 may transmit the content, metadata of the content, and the original content of the content to the external electronic device. For example, when the original content of the content exists, the communication module 210 may transmit the content and the metadata of the content to the external electronic device.

In an embodiment of the disclosure, the communication module 210 may transmit or receive the content and the information related to the content to or from the external electronic device, directly (e.g., device-to-device) or via a server (e.g., cloud server).

In an embodiment of the disclosure, the camera module 220 may be the camera module 180 of FIG. 1.

In an embodiment of the disclosure, the camera module 220 may obtain an image (e.g., a still image and/or a video). In an embodiment of the disclosure, the image obtained through the camera module 220 may be stored in the memory 240 (e.g., a second area 242 of the memory 240 to be described below).

In an embodiment of the disclosure, the display module 230 may be the display module 160 of FIG. 1.

In an embodiment of the disclosure, the display module 230 may display content. For example, the display module 230 may display content obtained (or received) while performing editing (or modification) on content (or after performing editing on the content).

In an embodiment of the disclosure, the memory 240 may be the memory 130 of FIG. 1.

In an embodiment of the disclosure, the memory 240 may include a first area 241 (also referred to as a “secure area”) and the second area 242 (also referred to as a “general area”).

In an embodiment of the disclosure, the first area 241 (hereinafter, referred to as the “first area”) of the memory 240 may be an area that stores a file related to an application (and/or a system). In an embodiment of the disclosure, the first area 241 of the memory 240 may be an area in which an application may access only a file of the application among files stored in the first area 241. For example, when the operating system (OS) of the electronic device 201 is Android™, the first area 241 of the memory 240 may be an internal storage (and/or an individual app space of an external storage).

In an embodiment of the disclosure, the first area 241 of the memory 240 may be an area set to store original content of edited content (and metadata of the edited content).

In an embodiment of the disclosure, the first area 241 of the memory 240 may be an area that is not accessible to a user of the electronic device 201 (or an area hidden from the user of the electronic device 201). For example, the first area 241 of the memory 240 may be an area set such that the user may not modify a file stored in the first area 241.

In an embodiment of the disclosure, the second area 242 (hereinafter, referred to as the “second area”) of the memory 240 may be an area for storing content, such as a photo and a video. In an embodiment of the disclosure, the second area 242 of the memory 240 may be an area in which an application may access a file of the application or files of other applications among files stored in the second area 242. For example, when the OS of the electronic device 201 is Android™, the second area 242 of the memory 240 may be a shared space of an external storage.

In an embodiment of the disclosure, the second area 242 of the memory 240 may be an area set to store edited content.

In an embodiment of the disclosure, the second area 242 of the memory 240 may be an area accessible to the user of the electronic device 201. For example, the second area 242 of the memory 240 may be an area that allows the user to access (e.g., save, read, and modify) a file stored in the second area 242.

In an embodiment of the disclosure, the processor 250 may be the processor 120 of FIG. 1.

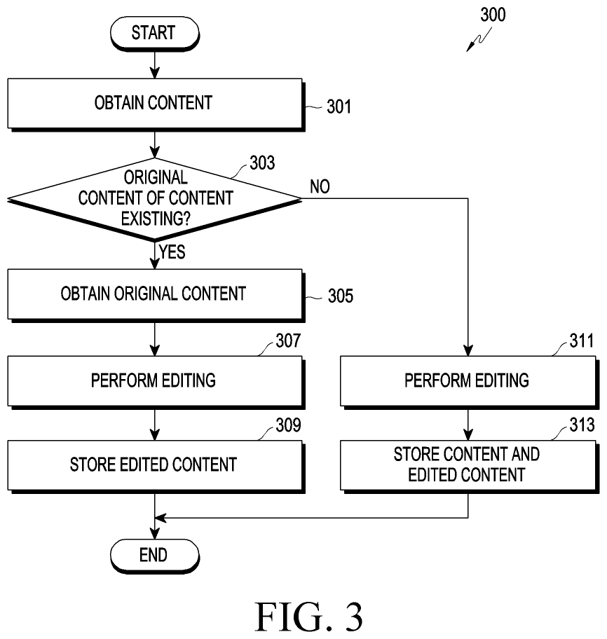

In an embodiment of the disclosure, the processor 250 may control an overall operation of providing a non-destructive editing function. In an embodiment of the disclosure, the processor 250 may include one or more processors for providing the non-destructive editing function. An operation of providing the non-destructive editing function by the processor 250 will be described below with reference to FIG. 3.

In FIG. 2, the electronic device 201 is shown as including the communication module 210, the camera module 220, the display module 230, the memory 240, and/or the processor 250, to which the electronic device 201 is not limited. For example, the electronic device 201 may not include some (e.g., the camera module 220 and/or the display module 230) of the components illustrated in FIG. 2. For example, the electronic device 201 may further include at least one of the components illustrated in FIG. 1 in addition to the components illustrated in FIG. 2.

FIG. 3 is a flowchart 300 illustrating a method for obtaining non-destructively editable content according to an embodiment of the disclosure.

Referring to FIG. 3, in operation 301, in an embodiment of the disclosure, the processor 250 may obtain (or receive) content. For example, the processor 250 may obtain content to be edited (hereinafter, referred to as “first content”).

In an embodiment of the disclosure, the first content may include at least one of an image (e.g., a still image and/or a video), audio, and/or text. For example, the first content may include editable media content.

In an embodiment of the disclosure, the processor 250 may obtain an image using the camera module 220 and store the obtained image in the memory 240. For example, the processor 250 may store the image obtained using the camera module 220 in the second area 242 of the memory 240.

In an embodiment of the disclosure, the processor 250 may receive content from an external electronic device (e.g., the external electronic device 102 or 104 or the server 108) through the communication module 210 and store the received content in the memory 240. For example, the processor 250 may store the content received from the external electronic device in the second area 242 of the memory 240.

In an embodiment of the disclosure, after the content is stored in the memory 240 (e.g., the second area 242 of the memory 240), the processor 250 may obtain the first content to be edited from the memory 240 during or after execution of an application (e.g., a gallery application or an image editing application).

In operation 303, in an embodiment of the disclosure, the processor 250 may identify whether original content of the content (the first content) exists.

In an embodiment of the disclosure, the processor 250 may identify whether the original content (hereinafter, also referred to as “second content”) of the first content exists by identifying whether the original content of the first content is stored in the memory 240 (e.g., the first area 241 of the memory 240). For example, when the processor 250 identifies that the original content of the first content is stored in the memory 240, the processor 250 may identify that the original content of the first content exists. When the processor 250 identifies that the original content of the first content is not stored in the memory 240, the processor 250 may identify that the original content of the first content does not exist.

In an embodiment of the disclosure, the processor 250 may identify whether the original content of the first content is stored in the memory 240 (e.g., the first area 241 of the memory 240) based on information (e.g., a flag value) related to the first content. For example, when the original content of the first content is stored in the memory 240, the flag value linked to the first content may be set to “1”. When the original content of the first content is not stored in the memory 240, the flag value linked to the first content may be set to “0”. The processor 250 may identify that the original content of the first content is stored in the memory 240, based on identifying that the flag value linked to the first content is set to “1”. The processor 250 may identify that the original content of the first content is not stored in the memory 240, based on identifying that the flag value linked to the first content is set to “0”.

In an embodiment of the disclosure, the processor 250 may identify whether the original content of the first content is stored in the memory 240 (e.g., the first area 241 of the memory 240) by identifying whether metadata of the first content includes a path (also referred to as a “storage path”) of the second content (or a storage location of the original content).

In an embodiment of the disclosure, when edited content is obtained (or generated) by performing editing using the non-destructive editing function, original content of the obtained edited content may be stored in the first area 241 of the memory 240 (e.g., a preset (or pre-specified) storage location corresponding to a path in the first area 241 of the memory 240) based on the path including the storage location, and the path of the original content may be included in the metadata of the edited content, together with editing information. As the original content is stored, when a flag value linked to first content exists in the metadata of the edited content, the processor 250 may set the flag to a value (e.g., “1”) indicating that the original content is stored.

In an embodiment of the disclosure, the processor 250 may identify that the original content of the first content is stored in the memory 240, based on identifying that the metadata of the first content includes the path of the original content. The processor 250 may identify that the original content of the first content is not stored in the memory 240, based on identifying that the metadata of the first content does not include the path of the original content.

When identifying that the original content of the content (the first content) exists in operation 303, the processor 250 may obtain (e.g., read from the storage path) the original content (the second content) of the content (the first content) in operation 305 in an embodiment. For example, the processor 250 may identify the path of the second content included in the metadata of the first content. The processor 250 may obtain the second content from the memory 240 based on the path of the second content.

In an embodiment of the disclosure, when the second content is obtained, the processor 250 may identify the editing information (hereinafter, also referred to as “content editing information”) included in the metadata of the first content.

In an embodiment of the disclosure, when the first content is obtained by performing editing on content to be edited (e.g., the content to be edited stored in the second area 242 of the memory 240) (hereinafter, also referred to as “third content”), the editing information about the first content may include information related to editing performed on the third content to obtain the first content. For example, when the content (first content) is obtained by performing editing on the content (third content) to be edited, the editing information about the first content may include information (e.g., an identifier of a filter, properties of the filter, and an applied value) related to a filter (e.g., a filter configured to change and/or add a visual effect and/or a property related to a style) applied to the content (third content) to be edited. However, the editing information about the first content is not limited to the filter information applied to the target content (third content) to be edited. For example, it may include information related to a modification, such as cropping.

In an embodiment of the disclosure, when the editing information about the first content is identified, the processor 250 may generate content to be displayed through the display module 230 by applying the editing information about the first content to the second content, and display the generated content through the display module 230.

In operation 307, in an embodiment of the disclosure, the processor 250 may perform editing using the original content (second content).

In an embodiment of the disclosure, the processor 250 may perform editing using the original content (second content) based on a user input. For example, the processor 250 may obtain a user input for selecting a different filter from the filter applied to the content (third content). The processor 250 may apply the selected different filter to the original content (second content) based on the obtained user input. For example, the processor 250 may obtain a user input for cropping a portion of the content generated by applying the editing information about the first content to the second content. The processor 250 may perform cropping on the generated content based on the obtained user input. For example, the processor 250 may obtain a user input for adding an object (e.g., an icon or a sticker) to the generated content. The processor 250 may add the object to the generated content based on the obtained user input. However, the method for performing editing on the original content is not limited to the examples described above.

In an embodiment of the disclosure, the processor 250 may obtain the edited content (hereinafter, also referred to as “fourth content”) by performing editing using the original content (second content).

In operation 309, in an embodiment of the disclosure, the processor 250 may store the edited content (fourth content) in the memory 240.

In an embodiment of the disclosure, the processor 250 may store the fourth content in the memory 240, based on a user input for storing the fourth content.

In an embodiment of the disclosure, the processor 250 may store the fourth content in the memory 240 by replacing the first content, based on a user input for storing the fourth content as non-destructively editable content. For example, based on obtaining a user input (e.g., a “save” input) for storing the fourth content as non-destructively editable content, the processor 250 may replace the first content with the fourth content (e.g., store the fourth content obtained by applying the editing information to the first content) in the memory 240, and set the name (and path) of the fourth content to the same name (and path) of the first content (e.g., maintain the name (and/or path) of the first content). In an embodiment of the disclosure, the processor 250 may store the fourth content in the memory 240, and include the path of the second content as the original content of the fourth content in metadata of the fourth content.

In an embodiment of the disclosure, based on obtaining a user input for storing the fourth content as non-destructively uneditable content, the processor 250 may store the edited fourth content in the memory 240 while maintaining the first content. For example, based on obtaining a user input (e.g., a “save as copy” input) for storing the fourth content as non-destructively uneditable content, the processor 250 may newly store the fourth content in the second area 242 of the memory 240 while maintaining the first content (e.g., without changing the first content stored in the second area 242 of the memory 240).

When identifying that the original content of the content (e.g., the second content of the first content) does not exist in operation 303, the processor 250 may perform editing on the content (the first content) in operation 311 in an embodiment.

In an embodiment of the disclosure, the processor 250 may perform editing using the first content based on a user input. For example, the processor 250 may obtain a user input for selecting a filter. The processor 250 may apply the filter selected based on the user input to the first content. For example, the processor 250 may obtain a user input for cropping a portion of the first content. The processor 250 may perform cropping on the first content based on the obtained user input. For example, the processor 250 may obtain a user input for adding an object to the first content. The processor 250 may add the object to the first content based on the user input. However, the method for performing editing on content is not limited to the above example.

In an embodiment of the disclosure, the processor 250 may obtain edited content (hereinafter, also referred to as “fifth content”) by performing editing using the first content.

In operation 313, in an embodiment of the disclosure, the processor 250 may store the edited content (fifth content) and the content (e.g., the original content of the fifth content) in the memory 240.

In an embodiment of the disclosure, based on obtaining a user input for storing the fifth content as non-destructively editable content, the processor 250 may store the same content (hereinafter, referred to as “sixth content”) as the first content stored in the second area 242 of the memory 240 as the original content of the fifth content in the first area 241 of the memory 240 (or move the first content stored in the second area 242 of the memory 240 to the first area 241 of the memory 240). For example, based on the user input for storing the fifth content as non-destructively editable content, the processor 250 may set (e.g., create) a path including a preset storage location (e.g., a folder (or directory)) for storing the original content. The processor 250 may move the sixth content to the first area 241 of the memory 240 (e.g., the storage location corresponding to the set path in the first area 241 of the memory 240) based on the set path. In an embodiment of the disclosure, when setting the path, the processor 250 may perform an operation of setting a name of the sixth content (e.g., a file name of the content) as a unique name. For example, when setting the path, the processor 250 may set a hash value obtained by applying a hash function to the name of the first content, as the name of the sixth content. For example, when setting the path, the processor 250 may set a hash value obtained by applying a hash function to at least a portion of the name of the first content and the storage location where the first content was stored, as the name of the sixth content. For example, when setting the path, the processor 250 may set a hash value obtained by applying a hash function to at least a portion of the first content (e.g., first content data), as the name of the sixth content. In an embodiment of the disclosure, when the path has been set, the processor 250 may include the set path (e.g., the path of the sixth content) in metadata of the fifth content.

In an embodiment of the disclosure, based on obtaining a user input for storing the fifth content as non-destructively editable content, the processor 250 may replace the first content with the fifth content and set the name (and path) of the fifth content to the name (and path) of the first content.

In an embodiment of the disclosure, when storing the sixth content in the first area 241 of the memory 240 (e.g., including the path of the sixth content in the metadata of the fifth content), the processor 250 may set a flag indicating that the fifth content is non-destructively editable content (e.g., set the flag value to “1”) and store the set flag in the memory 240 in association with the edited fifth content.

In an embodiment of the disclosure, based on obtaining a user input for storing the fifth content as non-destructively uneditable content, the processor 250 may store the fifth content in the second area 242 of the memory 240 without performing an operation of storing the sixth content in the first area 241 of the memory 240.

Although not described in the above examples, when editing is performed on the content (e.g., the first content or the content displayed through the display module 230 by applying editing information about the first content to the second content), the processor 250 may include, in the metadata of the edited content (e.g., the fourth content and the fifth content), a unique ID, a name, a creation date, an editing or modification date, and/or a creation location (e.g., when the content is an image, a location where the image was taken) of the content (and/or the original content of the content), together with the editing information (and the path of the original content).

In an embodiment of the disclosure, when the content (e.g., the first content) and the metadata of the content are configured as one file, the metadata of the edited content (e.g., the fourth content and the fifth content) and the edited content may also be configured as one file. The processor 250 may store the edited content configured as one file in the second area 242 of the memory 240.

In an embodiment of the disclosure, when the edited content (e.g., the fourth content and the fifth content) and the metadata of the edited content are configured as one file, the processor 250 may store the one file in the second area 242 of the memory 240, and store the metadata of the content in association with the edited content in the first area 241 of the memory 240.

In an embodiment of the disclosure, the edited content (data of the edited content) (e.g., the fourth content and the fifth content) and the metadata of the content may be configured as separate files. In this case, the processor 250 may store the content in the second area 242 of the memory 240, and store the metadata of the content in association with the content in the first area 241 of the memory 240.

In an embodiment of the disclosure, the processor 250 may preset a location (e.g., a folder (or directory)) for storing the original content (e.g., the second content and the sixth content) in the first area 241 (the first area 241 of the memory 240). For example, when installing (or updating) an application related to the non-destructive editing function, the processor 250 may set a storage location (or a path including the storage location) for storing the original content in the first area 241 of the memory 240.

In an embodiment of the disclosure, the storage location (or path) for storing the original content in the first area 241 of the memory 240 may be related to the OS of the electronic device 201 (e.g., may correspond to the OS of the electronic device 201). For example, the storage location (or path) for storing the original content in the first area 241 of the memory 240 may include a storage location (or path) unique to the OS of the electronic device 201. For example, the storage location (or path) for storing the original content in the first area 241 of the memory 240 may be a storage location (or path) that does not exist in an external electronic device that operates on an OS different from the OS of the electronic device 201.

In an embodiment of the disclosure, the storage location (or path) for storing the original content in the first area 241 of the memory 240 may be a storage location that is unchangeable by the user (e.g., a general user) of the electronic device 201. On the contrary, the storage location (or path) where the edited content (e.g., the fourth content and the fifth content) is stored in the second area 242 of the memory 240 may be a storage location that is changeable by the user (e.g., general user) of the electronic device 201.

In an embodiment of the disclosure, upon receipt of a user input for deleting the edited content (e.g., the fourth content and the fifth content), the processor 250 may delete the edited content and the original content of the edited content from the memory 240.

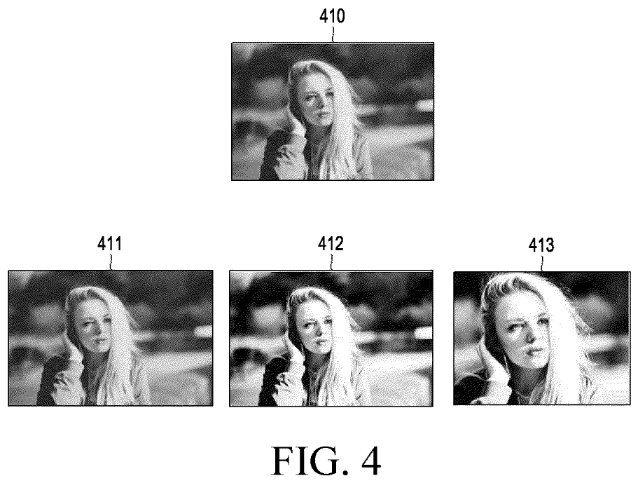

FIG. 4 is a diagram illustrating a method for obtaining non-destructively editable content according to an embodiment of the disclosure.

Referring to FIG. 4, in an embodiment of the disclosure, a first image 410 may be an original image of a second image 411. For example, the second image 411 may be an image generated by editing an image to be edited and stored in the second area 242 of the memory 240, and the first image 410 may be the original image of the second image 411, stored in the first area 241 of the memory 240. The second image 411 may be an image generated by applying a first filter (e.g., a filter that applies a warm tone to an image) to the image to be edited.

In an embodiment of the disclosure, the processor 250 may generate an image to be displayed through the display module 230 by applying editing information (e.g., the first filter) about the second image 411 to the first image 410, and display the generated image through the display module 230. For example, the processor 250 may generate a copy image of the first image 410, generate an image to be displayed through the display module 230 by applying the editing information (e.g., the first filter) about the second image 411 to the generated copy image, and display the generated image through the display module 230.

In an embodiment of the disclosure, the processor 250 may obtain a user input for applying a second filter (e.g., a filter that converts a color image into a black-and-white image) in place of the first filter, while displaying the generated image through the display module 230. The processor 250 may generate a third image 412 by applying the second filter to the first image 410 (e.g., the copy image of the first image 410) as the original image of the second image 411, based on the user input.

In an embodiment of the disclosure, the processor 250 may obtain a user input for cropping a portion of the third image 412, while displaying the third image 412 through the display module 230. The processor 250 may generate a fourth image 413 by performing cropping on the third image 412, based on the user input.

In an embodiment of the disclosure, after generating the fourth image 413, the processor 250 may store the fourth image 413 in the second area 242 of the memory 240, based on a user input for storing the fourth image 413 (e.g., a user input for storing the fourth image 413 as a non-destructively editable image). The processor 250 may include a path of the first image 410 as the original image of the fourth image 413 along with editing information (e.g., information related to the second filter and the crop) in metadata of the fourth image 413. The processor 250 may set a flag indicating that the fourth image 413 is a non-destructively editable image, after storing the fourth image 413 in the second area 242 of the memory 240.

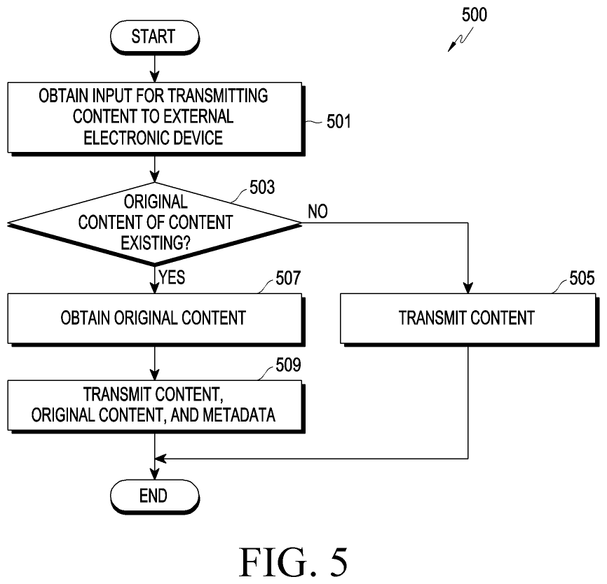

FIG. 5 is a flowchart 500 illustrating a method for providing a non-destructively editable function according to an embodiment of the disclosure.

Referring to FIG. 5, in operation 501, in an embodiment of the disclosure, the processor 250 may obtain (or receive) an input for transmitting content to an external electronic device. For example, the processor 250 may obtain a user input for transmitting content (hereinafter, also referred to as “first content”) to an external electronic device (e.g., the external electronic device 102 or 104).

In an embodiment of the disclosure, metadata of the first content may be data that is generated (or configured) as a single file in combination of the first content (e.g., first content data), or generated as a separate file from the first content (e.g., a file of the first content) and stored in the memory 240.

In operation 503, in an embodiment of the disclosure, the processor 250 may identify whether original content of the content exists.

In an embodiment of the disclosure, the processor 250 may identify whether the original content (hereinafter, also referred to as “second content”) of the first content is stored in the memory 240, based on information (e.g., a flag value) related to the first content. For example, the processor 250 may identify that the second content is stored in the memory 240, based on identifying that the flag value linked to the first content is set to “1.” The processor 250 may identify that the original content of the first content is not stored in the memory 240, based on identifying that the flag value linked to the first content is set to “0.”

In an embodiment of the disclosure, when identifying that the second content is stored in the memory 240 based on the information related to the first content, the processor 250 may identify that the original content of the content exists.

In an embodiment of the disclosure, the processor 250 may identify whether the metadata of the first content includes a path of the second content. When the metadata of the first content includes the path of the second content, the processor 250 may identify that the original content of the content exists. When the metadata of the first content does not include the path of the second content, the processor 250 may identify that the original content of the content does not exist.

In an embodiment of the disclosure, when identifying that the metadata of the first content includes the path of the second content, the processor 250 may identify that the second content is actually stored in the path of the second content, included in the metadata of the first content. When identifying that the second content is actually stored in the path of the second content included in the metadata of the first content, the processor 250 may identify that the original content of the content exists. When identifying that the second content is not actually stored in the path of the second content included in the metadata of the first content, the processor 250 may identify that the original content of the content does not exist.

In an embodiment of the disclosure, the operation of identifying whether the original content of the content exists may be an operation of identifying whether the first content is non-destructively editable content. For example, when identifying that the second content exists, the processor 250 may identify that the first content is non-destructively editable content. When identifying that the second content does not exist, the processor 250 may identify that the first content is not non-destructively editable content.

When identifying that the original content of the content does not exist in operation 503, in an embodiment of the disclosure, the processor 250 may transmit the first content (and the metadata of the first content) to an external electronic device through the communication module 210 in operation 505.

When identifying that the original content of the content exists in operation 503, in an embodiment of the disclosure, the processor 250 may obtain the original content of the content in operation 507.

In an embodiment of the disclosure, the processor 250 may identify the path of the second content included in the metadata of the first content. The processor 250 may obtain the second content based on the identified path.

In operation 509, in an embodiment of the disclosure, the processor 250 may transmit the content (the first content), the original content (the second content), and the metadata (the metadata of the first content) to the external electronic device through the communication module 210.

In an embodiment of the disclosure, the processor 250 may transmit information indicating that the first content is non-destructively editable content, along with the first content, the second content, and the metadata of the first content, to the external electronic device through the communication module 210.

In an embodiment of the disclosure, the processor 250 may additionally transmit, to the external electronic device through the communication module 210, the information indicating that the first content is non-destructively editable content and/or information indicating the OS of the electronic device 201, along with the first content, the second content, and the metadata of the first content. The information indicating the OS may be transmitted at a different time from a time when the content is transmitted. For example, it may be transmitted at a time when the processor 250 establishes a connection with the external electronic device, but the time is not limited.

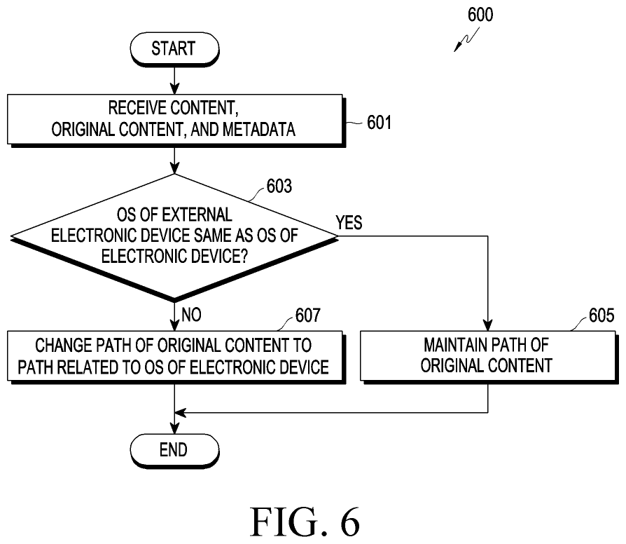

FIG. 6 is a flowchart 600 illustrating a method for providing a non-destructively editable function according to an embodiment of the disclosure.

Referring to FIG. 6, in operation 601, in an embodiment of the disclosure, the processor 250 may receive content, original content of the content, and metadata from an external electronic device (e.g., the external electronic device 102 or 104) through the communication module 210.

In an embodiment of the disclosure, based on receiving the content (hereinafter, also referred to as “first content”), the original content (hereinafter, also referred to as “second content”) of the content, and the metadata from the external electronic device through the communication module 210, the processor 250 may store the first content in the memory 240. For example, the processor 250 may store the first content in the second area 242 of the memory 240, based on a storage path preset to store edited content.

In operation 603, in an embodiment of the disclosure, the processor 250 may identify whether an OS of the external electronic device is same as the OS of the electronic device 201.

In an embodiment of the disclosure, the processor 250 may further receive information indicating the OS of the external electronic device from the external electronic device through the communication module 210. The processor 250 may identify the OS of the external electronic device based on the received information. When the processor 250 does not receive the information indicating the OS of the external electronic device, the processor 250 may identify the OS of the external electronic device based on other information (e.g., storage path information included in the metadata). The method for identifying the OS of the external electronic device by the processor 250 is not limited.

In an embodiment of the disclosure, the processor 250 may identify the OS of the external electronic device based on a path of the second content included in the metadata of the first content. For example, a table in which OSs are mapped to storage locations (and paths including the storage locations) at which original content is stored may be stored in the memory 240. The processor 250 may identify the OS of the external electronic device by identifying an OS mapped to a storage location included in the path of the second content.

When identifying that the OS of the external electronic device is same as the OS of the electronic device 201 in operation 603, in an embodiment of the disclosure, the processor 250 may maintain the path of the original content included in the metadata of the first content in operation 605. For example, when identifying that the OS of the external electronic device is same as the OS of the electronic device 201, the processor 250 may not change the path of the original content included in the metadata of the first content.

In an embodiment of the disclosure, the processor 250 may store the original content of the first content in the first area 241 of the memory 240 based on the path of the original content included in the metadata of the first content. For example, the processor 250 may create a folder corresponding to the path of the original content included in the metadata of the first content, and store the original content of the first content in the created folder. For example, when a folder with the same name as that of the folder of the path of the original content included in the metadata of the first content exists in the electronic device 201, the processor 250 may store the original content of the first content in the folder with the same name.

In an embodiment of the disclosure, the processor 250 may store the metadata of the first content in the memory 240. For example, when the processor 250 receives a file in which the metadata of the first content and the first content are combined from the external electronic device, the processor 250 may store the received file in the second area 242 of the memory 240. For example, when the processor 250 receives the file in which the metadata of the first content and the first content are combined from the external electronic device, the processor 250 may store the received file in the second area 242 of the memory 240, generate metadata same as the metadata of the first content, and store the same metadata in the first area 241 of the memory 240. For example, when the metadata of the first content and the first content are received as separate files from the external electronic device, the processor 250 may store the first content in the second area 242 of the memory 240 and store the metadata of the first content in the first area 241 of the memory 240. However, the disclosure is not limited thereto, and the metadata of the first content may also be stored in the second area 242 of the memory 240.

When identifying that the OS of the external electronic device is not same as the OS of the electronic device 201 in operation 603, in an embodiment of the disclosure, the processor 250 may change the path of the original content included in the metadata of the first content to a path related to the OS of the electronic device 201 in operation 607.

In an embodiment of the disclosure, when identifying that the OS of the external electronic device is not same as the OS of the electronic device 201, the processor 250 may identify the path of the second content included in the metadata of the first content. The processor 250 may change the path of the second content included in the metadata of the first content to a path which is related to the OS of the electronic device 201 (e.g., corresponds to the OS of the electronic device 201) and includes a storage location preset to store the original content.

In an embodiment of the disclosure, the processor 250 may store the original content of the first content in the first area 241 of the memory 240, based on the path related to the OS of the electronic device 201 as the changed path.

In an embodiment of the disclosure, the processor 250 may store metadata of the first content including the changed path in the memory 240. For example, when the processor 250 receives a single file in which the metadata of the first content and the first content are combined from the external electronic device, the processor 250 may change the path of the second content in the metadata of the first content to the path related to the OS of the electronic device 201, and store the metadata including the changed path and the first content as a single file in the second area 242 of the memory 240. For example, when the processor 250 receives a single file in which the metadata of the first content and the first content are combined from the external electronic device, the processor 250 may change the path of the second content in the metadata of the first content to the path related to the OS of the electronic device 201, store the metadata of the first content including the changed path and the first content as a single file in the second area 242 of the memory 240, generate metadata same as the metadata including the changed path, and store the same metadata in the first area 241 of the memory 240. For example, when the metadata of the first content and the first content are received as separate files from the external electronic device, the processor 250 may store the first content in the second area 242 of the memory 240, change the path of the second content in the metadata of the first content to the path related to the OS of the electronic device 201, and store the metadata of the first content including the changed path in the first area 241 of the memory 240.

Although not described above, in an embodiment of the disclosure, upon receipt of the content from the external electronic device through the communication module 210, the processor 250 may identify whether the received content is non-destructively editable content. For example, the processor 250 may identify whether the received content is non-destructively editable content (or whether the original content of the content has been received from the external electronic device, together with the content) based on information (e.g., a flag value) related to the received content. For example, the processor 250 may identify whether the received content is non-destructively editable content based on the path of the original content included in the metadata of the received content.

In an embodiment of the disclosure, when identifying the received content (e.g., first content) is non-destructively uneditable content (e.g., when identifying that the original content of the received content has not been received from the external electronic device), the processor 250 may store the received content and the metadata of the received content in the memory 240.

In an embodiment of the disclosure, when identifying that the received content (e.g., first content) is non-destructively editable content, the processor 250 may perform at least some of operations 601 to 605.

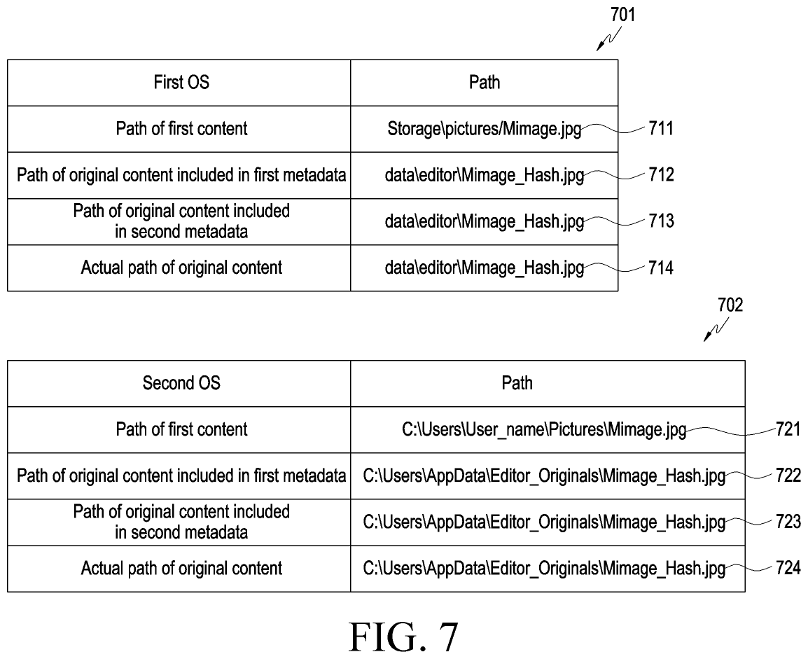

FIG. 7 is a diagram illustrating a method for providing a non-destructively editable function according to an embodiment of the disclosure.

Referring to reference numeral 701 in FIG. 7, in an embodiment of the disclosure, a first electronic device operating using a first OS (e.g., Android™) (e.g., the electronic device 201 operating using the first OS) may store first content in a first path (“Storage/pictures/Mimage.jpg”) 711.

In the first path 711, “Storage/pictures” may indicate a storage location (e.g., a folder or directory) of the first content, and “Mimage.jpg” may indicate a name (file name) of the first content.

A path of original content included in first metadata generated as a single file with the first content may be set to a second path (“data/editor/Mimage_Hash.jpg”) 712. In the second path 712, “data/editor” may indicate a storage location (e.g., a storage location preset to store original content) of the original content of the first content in the first area (e.g., the first area 241) of the first electronic device, and “Mimage_Hash.jpg” may indicate a hash value of a name of the first content as a name (file name) of the original content of the first content.

A path of the original content included in second metadata of the first content, stored in a first area (e.g., the first area 241) of the memory of the first electronic device, may be set to a third path (“data/editor/Mimage_Hash.jpg”) 713. In the third path 713, “data/editor” indicates the storage location of the original content of the first content in the first memory of the first electronic device, and “Mimage_Hash.jpg” may indicate the hash value of the name of the first content as the name (file name) of the original content of the first content.

In an embodiment of the disclosure, as illustrated in reference numeral 701, the second path 712 of the original content included in the first metadata generated as a single file with the first content and the third path 713 of the original content included in the second metadata of the first content stored in the first area of the memory of the first electronic device may be the same.

In an embodiment of the disclosure, as illustrated in reference numeral 701, the second path 712 and the third path 713 may be the same as an actual path 714 of the original content of the first content (e.g., a path where the original content of the first content is actually stored in the first electronic device).

In an embodiment of the disclosure, the first electronic device operating using the first OS (e.g., Android™) may transmit the first content, the original content of the first content, and the metadata of the first content to a second electronic device operating using a second OS (e.g., Windows™) different from the first OS.

Referring to reference numeral 702 in FIG. 7, the second electronic device operating using the second OS may receive the first content, the original content of the first content, and the metadata of the first content from the first electronic device. For example, the second electronic device may receive the first content and the metadata of the first content configured as one file, together with the first content from the first external electronic device. However, the disclosure is not limited thereto, and the second electronic device may receive the original content of the first content and the metadata of the first content as separate files, together with the first content.

In an embodiment of the disclosure, the second electronic device may store the first content received from the first electronic device in a fourth path (“C:/Users/User_name/Pictures/Mimage.jpg”) 721.

In an embodiment of the disclosure, the second electronic device may change the second path (“data/editor/Mimage_Hash.jpg”) included in the first metadata of the first content received from the first electronic device and configured as a single file with the first content to a preset fifth path (“C:/Users/AppData/Editor_Originals/Mimage_Hash.jpg”) 722. In the fifth path 722, “C:/Users/AppData/Editor_Originals” may indicate a storage location of the original content of the first content (e.g., a storage location preset to store original content) in the first area (e.g., the first area 241) of the second electronic device, and “Mimage_Hash.jpg” may indicate the hash value of the name of the first content as the name of the original content of the first content.

In an embodiment of the disclosure, the second electronic device may generate second metadata including a sixth path 723 same as the fifth path 722 and store it in a first area (e.g., the first area 241) of the memory (e.g., the memory 240) of the second electronic device.

In an embodiment of the disclosure, as illustrated in reference numeral 702, the fifth path 722 of the original content included in the first metadata generated as a single file with the first content and the sixth path 723 of the original content included in the second metadata of the first content stored in the first area 241 of the memory 240 of the first electronic device may be the same.

In an embodiment of the disclosure, as illustrated in reference numeral 702, the fifth path 722 and the sixth path 723 may be the same as an actual path 724 of the original content of the first content (e.g., a path where the original content of the first content is actually stored in the second electronic device).

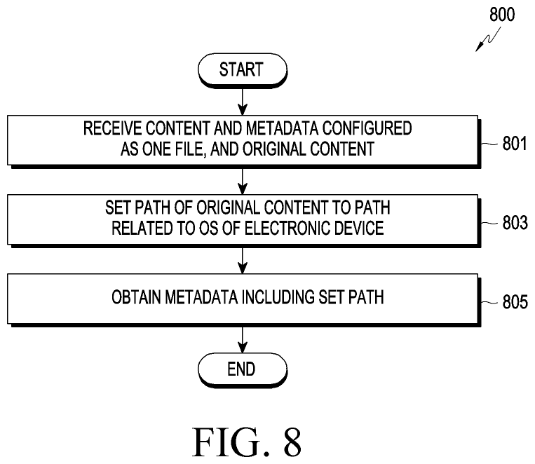

FIG. 8 is a flowchart 800 illustrating a method for providing a non-destructive editing function according to an embodiment of the disclosure.

Referring to FIG. 8, in operation 801, in an embodiment of the disclosure, the processor 250 may receive content (hereinafter, referred to as “first content”) and metadata (e.g., metadata of the first content) which are configured as a single file, and original content (e.g., original content of the first content) from an external electronic device (e.g., the external electronic device 102 or 104) through the communication module 210.

In operation 803, in an embodiment of the disclosure, the processor 250 may set a path of the original content of the first content to a path related to the OS of the electronic device 201.

In an embodiment of the disclosure, the processor 250 may identify a path of the original content of the first content included in the metadata of the first content. When a storage location included in the identified path is different from a storage location preset for storing the original content, the processor 250 may set the path where the original content of the first content is to be stored to the path related to the OS of the electronic device 201. When the storage location included in the identified path is the same as the storage location preset for storing the original content, the processor 250 may set the identified path as the path where the original content of the first content is to be stored.

In operation 805, in an embodiment of the disclosure, the processor 250 may obtain (e.g., generate) metadata of the first content including the set path. The processor 250 may store the generated metadata in the first area 241 of the memory 240.

In an embodiment of the disclosure, the processor 250 may store the original content of the first content in the set path.

In an embodiment of the disclosure, the processor 250 may store the first content and the metadata of the first content which are configured as one file in the second area 242 of the memory 240 without changing the first content and the metadata of the first content which are configured as one file.

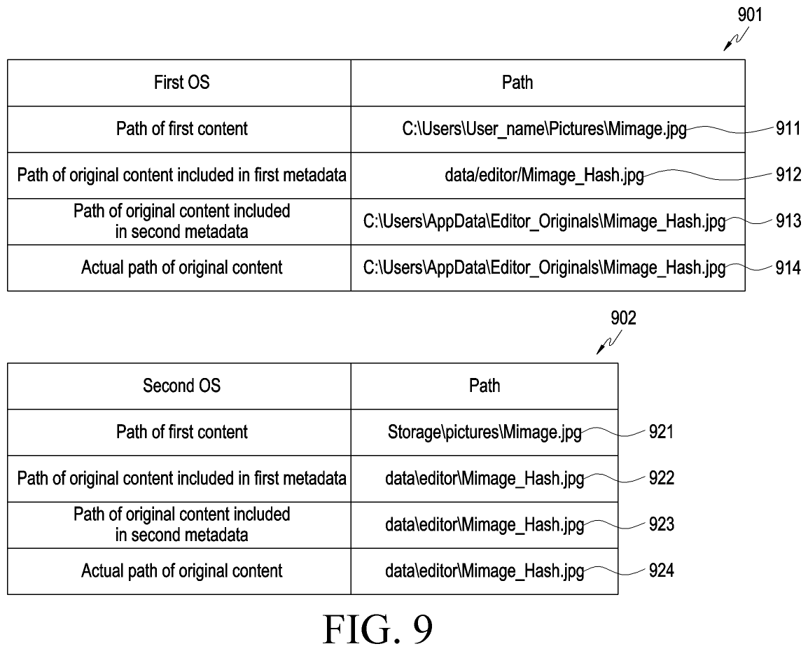

FIG. 9 is a diagram illustrating a method for providing a non-destructive editing function according to an embodiment of the disclosure.

In an embodiment of the disclosure, FIG. 9 may be a diagram illustrating examples of the operations described with reference to FIG. 8.

Referring to reference numeral 901 in FIG. 9, in an embodiment of the disclosure, a first electronic device operating using a first OS (e.g., Windows™) (e.g., the electronic device 201 operating using the first OS) may store first content in a first path (“C:/Users/User_name/Pictures/Mimage.jpg”) 911.

In the first path 911, “C:/Users/User_name/Pictures” may indicate a storage location (e.g., a folder or directory) of the first content, and “Mimage.jpg” may indicate a name (file name) of the first content.

A path of original content included in first metadata generated as one file with the first content may be a second path “data/editor/Mimage_Hash.jpg” 912. For example, when the first electronic device obtains the first content by editing content to be edited, the first electronic device may not change the metadata of the content to be edited, which is configured as a single file with the content. In this case, a path of the original content of the content to be edited in the metadata of the content to be edited, which is configured as a single file with the content to be edited may also not be changed. The second path “data/editor/Mimage_Hash.jpg” 912 may be the path of the original content of the content to be edited.

A path of the original content included in second metadata of the first content, which is stored in the first area (e.g., the first area 241) of the memory (e.g., the memory 240) of the first electronic device and generated as a separate file from the first content may be to set a third path “C:/Users/AppData/Editor_Originals/Mimage_Hash.jpg” 913. In the third path 913, “C:/Users/AppData/Editor_Originals” indicates the storage location of the original content of the first content in the first memory of the first electronic device, and “Mimage_Hah.jpg” may indicate a hash value of the name of the first content as the name (file name) of the original content of the first content.

In an embodiment of the disclosure, as illustrated in reference numeral 901, the second path 912 of the original content included in the first metadata generated as a single file with the first content may be different from the third path 913 of the original content included in the second metadata of the first content stored in the first area of the memory of the first electronic device.

In an embodiment of the disclosure, as illustrated in reference numeral 901, the third path 913 may be the same as an actual path 914 of the original content of the first content (e.g., a path where the original content of the first content is actually stored in the first electronic device).

In an embodiment of the disclosure, the first electronic device operating using the first OS (e.g., Windows™) may transmit the first content configured as a single file with the metadata including the second path 912 (or the first content and the metadata including the third path 913) and the original content of the first content to a second electronic device operating using a second OS (e.g., Android™) different from the first OS.

Referring to reference numeral 902 of FIG. 9, the second electronic device operating using the second OS may receive the first content configured as a single file with the metadata including the second path 912 (or the first content and the metadata including the third path 913) and the original content of the first content.

In an embodiment of the disclosure, the second electronic device may store the first content received from the first electronic device in a fourth path (“Storage/pictures/Mimage.jpg”) 921.

In an embodiment of the disclosure, the second electronic device may not change the metadata (first metadata) of the first content configured as a single file with the first content, received from the first electronic device. In this case, the second path (“data/editor/Mimage_Hash.jpg”) 922 included in the metadata of the first content configured as a single file with the first content may be maintained.

In an embodiment of the disclosure, the second electronic device may set the path of the original content of the first content to a preset fifth path (“data/editor/Mimage_Hash.jpg”) 923. The second electronic device may obtain second metadata including the fifth path 923. The second electronic device may store the obtained second metadata in the first area (e.g., the first area 241) of the memory (e.g., the memory 240) of the second electronic device, based on the fifth path 923.

In an embodiment of the disclosure, as illustrated in reference numeral 902, the fifth path 923 and an actual path 924 of the original content of the first content (e.g., a path where the original content of the first content is actually stored in the second electronic device) may be the same.

The electronic device 201 according to an embodiment of the disclosure may include the communication module 210, the processor 250, and the memory 240 storing instructions. The instructions, when executed by the processor 250, may cause the electronic device 201 to receive first content, original content of the first content, and metadata of the first content from an external electronic device through the communication module 210. The instructions, when executed by the processor 250, may cause the electronic device 201 to identify whether an OS of the external electronic device is same as an OS of the electronic device 201. The instructions, when executed by the processor 250, may cause the electronic device 201 to, based on identifying that the OS of the external electronic device is not same as the OS of the electronic device 201, change a path of the original content included in the metadata to a path related to the OS of the electronic device 201. The instructions, when executed by the processor 250, may cause the electronic device 201 to, based on identifying that the OS of the external electronic device is same as the OS of the electronic device 201, maintain the path of the original content included in the metadata.

In an embodiment of the disclosure, the instructions, when executed by the processor 250, may cause the electronic device 201 to store the original content in the first area 241 of the memory 240, based on the first content and the metadata being included in one file, store the first content and the metadata in the second area 242 of the memory 240, and based on the first content and the metadata being included in separate files, store the first content in the second area 242 and store the metadata in the first area 241.

In an embodiment of the disclosure, the instructions, when executed by the processor 250, may cause the electronic device 201 to identify that the first content is non-destructively editable content, based on information related to the first content and/or the path of the original content in the metadata.

In an embodiment of the disclosure, the instructions, when executed by the processor 250, may cause the electronic device 201 to identify whether the OS of the external electronic device is same as the OS of the electronic device 201 based on information about the OS of the external electronic device received from the external electronic device and/or the path of the original content included in the metadata.

In an embodiment of the disclosure, the electronic device 201 may further include the display module 230, and the instructions, when executed by the processor 250, may cause the electronic device 201 to obtain the first content after the first content is stored in the memory 240, based on identifying that the first content is content for which original content exists, obtain the original content of the first content based on the path of the original content of the first content included in the metadata stored in the memory 240, obtain editing information about the first content included in the metadata, obtain content to be displayed through the display module 230 by applying the editing information to the original content of the first content, and display the obtained content through the display module 230.

In an embodiment of the disclosure, the instructions, when executed by the processor 250, may cause the electronic device 201 to obtain edited content by editing the obtained content based on a user input, and the path of the original content of the first content included in the metadata stored in the memory 240 may be maintained.

In an embodiment of the disclosure, the electronic device 201 may further include display module 230, and the instructions, when executed by the processor 250, may cause the electronic device 201 to obtain second content, based on identifying that the second content is content for which original content exists, display the second content through the display module, obtain edited second content by editing the second content based on a user input, generate the original content of the second content, and set a path of the generated original content, predefined in relation to the OS of the electronic device 201.

In an embodiment of the disclosure, the path of the generated original content may include a hash value of a name of the second content or a hash value of the second content.

In an embodiment of the disclosure, the instructions, when executed by the processor 250, may cause the electronic device 201 to delete the second content and the generated original content based on a user input for deleting the second content.

In an embodiment of the disclosure, a method for providing a non-destructive editing function in the electronic device 201 may include receiving first content, original content of the first content, and metadata of the first content from an external electronic device through the communication module 210 of the electronic device 201. The method may include identifying whether an OS of the external electronic device is same as an OS of the electronic device 201. The method may include, based on identifying that the OS of the external electronic device is not same as the OS of the electronic device 201, changing a path of the original content included in the metadata to a path related to the OS of the electronic device 201. The method may include, based on identifying that the OS of the external electronic device is same as the OS of the electronic device 201, maintaining the path of the original content included in the metadata.

In an embodiment of the disclosure, the method may further include storing the original content in the first area 241 of the memory 240 of the electronic device 201, based on the first content and the metadata being generated as one file, storing the first content and the metadata in a second area 242 of the memory 240, and based on the first content and the metadata being generated as separate files, storing the first content in the second area 242 and storing the metadata in the first area 241.

In an embodiment of the disclosure, the method may further include identifying that the first content is non-destructively editable content, based on information related to the first content and/or the path of the original content in the metadata.

In an embodiment of the disclosure, identifying whether the OS of the external electronic device is same as the OS of the electronic device 201 may include identifying whether the OS of the external electronic device is same as the OS of the electronic device 201, based on information about the OS of the external electronic device received from the external electronic device and/or the path of the original content included in the metadata.

In an embodiment of the disclosure, the method may further include obtaining the first content after the first content is stored in the memory 240 of the electronic device 201, based on identifying that the first content is content for which original content exists, obtaining the original content of the first content based on the path of the original content of the first content included in the metadata stored in the memory 240, obtaining editing information about the first content included in the metadata, obtaining content to be displayed through a display module 230 by applying the editing information to the original content of the first content, and displaying the obtained content through the display module 230.

In an embodiment of the disclosure, the method may further include obtaining edited content by editing the obtained content based on a user input, and the path of the original content of the first content included in the metadata stored in the memory 240 may be maintained.

In an embodiment of the disclosure, the method may further include obtaining second content, based on identifying that the second content is content for which original content exists, displaying the second content through the display module 230 of the electronic device 101, obtaining edited second content by editing the second content based on a user input, generating the original content of the second content, and setting a path of the generated original content, predefined in relation to the OS of the electronic device 201.

In an embodiment of the disclosure, the path of the generated original content may include a hash value of a name of the second content or a hash value of the second content.

In an embodiment of the disclosure, the method may further include deleting the second content and the generated original content based on a user input for deleting the second content.

The electronic device 201 according to an embodiment of the disclosure may include the communication module 210, the processor 250, and the memory 240 storing instructions. The instructions, when executed by the processor 250, may cause the electronic device 201 to receive first content and metadata of the first content configured as one file, and original content of the first content from an external electronic device through the communication module 210. The instructions, when executed by the processor 250, may cause the electronic device 201 to set a path of the original content to a path related to an OS of the electronic device 201, based on a path of the original content included in the metadata. The instructions, when executed by the processor 250, may cause the electronic device 201 to obtain metadata including the set path. The instructions, when executed by the processor 250, may cause the electronic device 201 to store the obtained metadata in the memory 240.

In an embodiment of the disclosure, the instructions, when executed by the processor 250, may cause the electronic device 201 to store the original content and the obtained metadata in the first area 241 of the memory 240, and store the first content and the metadata of the first content configured as the one file in the second area 242 of the memory 240.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
communication circuitry;
at least one processor including processing circuitry;
memory storing instructions that, when executed by the at least one processor individually or collectively, cause the electronic device to:
receive, from an external electronic device through the communication circuitry, first content, original content of the first content, and metadata of the first content,
identify whether an operating system (OS) of the external electronic device is same as an OS of the electronic device,
based on identifying that the OS of the external electronic device is not same as the OS of the electronic device, change a path of the original content included in the metadata to a path related to the OS of the electronic device, and
based on identifying that the OS of the external electronic device is same as the OS of the electronic device, maintain the path of the original content included in the metadata.

2. The electronic device of claim 1, wherein the instructions, when executed by the at least one processor individually or collectively, cause the electronic device to:
store the original content in a first area of the memory,
based on the first content and the metadata being included in one file, store the first content and the metadata in a second area of the memory, and
based on the first content and the metadata being included in separate files, store the first content in the second area and store the metadata in the first area.

3. The electronic device of claim 1, wherein the instructions, when executed by the at least one processor individually or collectively, cause the electronic device to:
based on information related to the first content and/or the path of the original content in the metadata, identify that the first content is non-destructively editable content.

4. The electronic device of claim 1, wherein the instructions, when executed by the at least one processor individually or collectively, cause the electronic device to:
based on information about the OS of the external electronic device received from the external electronic device and/or the path of the original content included in the metadata, identify whether the OS of the external electronic device is same as the OS of the electronic device.

5. The electronic device of claim 1, wherein the instructions, when executed by the at least one processor individually or collectively, cause the electronic device to:
after the first content is stored in the memory, obtain the first content,
based on identifying that the first content is content for which original content exists, obtain the original content of the first content based on the path of the original content of the first content, the path of the original content of the first content being included in the metadata stored in the memory;
obtain editing information about the first content, the editing information being included in the metadata;
obtain content to be displayed through a display by applying the editing information to the original content of the first content; and
display the obtained content through the display.

6. The electronic device of claim 5,
wherein the instructions, when executed by the at least one processor individually or collectively, cause the electronic device to:
by editing the obtained content based on a user input, obtain edited content, and
wherein the path of the original content of the first content is maintained, the path of the original content of the first content being included in the metadata stored in the memory.

7. The electronic device of claim 1, further comprising:
a display,
wherein the instructions, when executed by the at least one processor individually or collectively, cause the electronic device to:
obtain second content,
based on identifying that the second content is content for which original content exists, display the second content through the display,
by editing the second content based on a user input, obtain edited second content,
generate the original content of the second content, and
set a path of the generated original content, predefined in relation to the OS of the electronic device.

8. The electronic device of claim 7, wherein the path of the generated original content includes a hash value of a name of the second content or a hash value of the second content.

9. The electronic device of claim 7, wherein the instructions, when executed by the at least one processor individually or collectively, cause the electronic device to:
based on a user input for deleting the second content, delete the second content and the generated original content.

10. A method for providing a non-destructive editing function in an electronic device, the method comprising:
receiving, through communication circuitry of the electronic device, first content, original content of the first content, and metadata of the first content from an external electronic device;
identifying whether an operating system (OS) of the external electronic device is identical to an OS of the electronic device;
based on identifying that the OS of the external electronic device is not same as the OS of the electronic device, changing a path of the original content included in the metadata to a path related to the OS of the electronic device; and
based on identifying that the OS of the external electronic device is same as the OS of the electronic device, maintaining the path of the original content included in the metadata.

11. The method of claim 10, further comprising:
storing the original content in a first area of memory of the electronic device;
based on the first content and the metadata being generated as one file, storing the first content and the metadata in a second area of the memory; and
based on the first content and the metadata being generated as separate files, storing the first content in the second area and storing the metadata in the first area.

12. The method of claim 10, further comprising:
based on information related to the first content and/or the path of the original content in the metadata, identifying that the first content is non-destructively editable content.

13. The method of claim 10, wherein the identifying of whether the OS of the external electronic device is same as the OS of the electronic device comprises:
based on information about the OS of the external electronic device received from the external electronic device and/or the path of the original content included in the metadata, identifying whether the OS of the external electronic device is same as the OS of the electronic device.

14. The method of claim 10, further comprising:
after the first content is stored in the memory of the electronic device, obtaining the first content;
based on identifying that the first content is content for which original content exists, obtaining the original content of the first content based on the path of the original content of the first content, the path of the original content of the first content being included in the metadata stored in the memory;
obtaining editing information about the first content, the editing information being included in the metadata;
obtaining content to be displayed through a display by applying the editing information to the original content of the first content; and
displaying the obtained content through the display.

15. The method of claim 14, further comprising:
by editing the obtained content based on a user input, obtaining edited content,
wherein the path of the original content of the first content is maintained, the path of the original content of the first content being included in the metadata stored in the memory.

16. The method of claim 10, further comprising:
obtaining second content;
based on identifying that the second content is content for which original content exists, displaying the second content through a display;
by editing the second content based on a user input, obtaining edited second content;
generating the original content of the second content; and
setting a path of the generated original content, predefined in relation to the OS of the electronic device.

17. The method of claim 16, wherein the path of the generated original content includes a hash value of a name of the second content or a hash value of the second content.

18. The method of claim 16, further comprising:
based on a user input for deleting the second content, deleting the second content and the generated original content.

19. An electronic device comprising:
communication circuitry;
at least one processor including processing circuitry;
memory storing the instructions that, when executed by the at least one processor individually or collectively, cause the electronic device to:
receive first content and metadata of the first content configured as one file, and original content of the first content from an external electronic device through the communication circuitry,
set a path of the original content to a path related to an OS of the electronic device, based on a path of the original content included in the metadata,
obtain metadata including the set path, and
store the obtained metadata in the memory.

20. The electronic device of claim 19, wherein the instructions, when executed by the at least one processor individually or collectively, cause the electronic device to:
store the original content and the obtained metadata in the first area of the memory, and
store the first content and the metadata of the first content configured as the one file in the second area of the memory.
